(19) United States
(12) Patent Application Publication
(10) Pub. No.: US 2014/0184853 A1
(43) Pub. Date: Jul. 3, 2014

(54) IMAGE PROCESSING APPARATUS, IMAGE PROCESSING METHOD, AND IMAGE PROCESSING PROGRAM

(71) Applicant: CANON KABUSHIKI KAISHA, Tokyo (JP)

(72) Inventor: Shigeo Ogawa, Yokohama-shi (JP)

(73) Assignee: CANON KABUSHIKI KAISHA, Tokyo (JP)

(21) Appl. No.: 14/139,684

(22) Filed: Dec. 23, 2013

(30) Foreign Application Priority Data
Dec. 27, 2012 (JP) 2012-285262

(51) Int. Cl. H04N 5/262

(52) U.S. Cl. CPC H04N 5/262
USPC 348/239

(57) ABSTRACT

An image processing apparatus includes an image acquisition unit configured to acquire image data, a distance information acquisition unit configured to acquire distance information from a plurality of areas of the image data, a detection unit configured to detect whether the distance information changes gradually in a certain direction within an image of the image data, and a blurring processing unit configured to perform blurring processing in a direction orthogonal to the certain direction if the detection unit has detected that the distance information changes gradually in the certain direction.

### BACKGROUND

1. Field

The present subject matter relates to an image processing apparatus, an image processing method, and an image processing program for performing blurring processing on image data.

2. Description of the Related Art

Some cameras are provided with a processing function emphasizing an object from a background. In such processing, an angle of view is divided into a plurality of blocks to obtain a distance from an object in each block. Then, blurring processing is applied to an area that has been determined as the background.

Japanese Laid-Open Patent Application No. 2009-219085 discusses a method in which parameters in blurring processing are varied according to defocus amounts and diaphragm values of a plurality of locations within an angle of view.

Japanese Laid-Open Patent Application No. 2009-27298 discusses a method for detecting blocks of a main object and performing blurring processing on areas other than the main object.

Conventionally, such a camera has had to separate the main object from the background in each small block unit due to issues such as detection accuracy of a distance and processing time, and it has been difficult to deal with a change in the distance within a block. In particular, if the distance is obtained using autofocus (AF) information, constraints of the AF disadvantageously limit the performance. For example, if an external sensor is used, it is difficult to obtain the distance of a peripheral angle of view. Meanwhile, even if the AF is performed using an image sensor, since the image is divided into a plurality of blocks to measure the distance, the distance cannot be obtained with precision of equal to or lower than a block size.

With the method in which the main object is separated from the background based on the distances in the plurality of blocks within the angle of view and the background blurring processing is thus performed, there has been an issue that the processing at a boundary area between the main object and the background becomes unnatural. In particular, in the case where the distances in the plurality of blocks within the angle of view are obtained through the AF, if the AF fails to measure the distances correctly, blurring processing may become uneven, since the main object is not properly separated from the background.

### SUMMARY

According to an aspect of the present subject matter, an image processing apparatus includes an image acquisition unit configured to acquire image data, a distance information acquisition unit configured to acquire distance information from a plurality of areas of the image data, a detection unit configured to detect whether the distance information changes gradually in a certain direction within an image of the image data, and a blurring processing unit configured to perform blurring processing in a direction orthogonal to the certain direction if the detection unit has detected that the distance information changes gradually in the certain direction.

Further features of the present subject matter will become apparent from the following description of exemplary embodiments with reference to the attached drawings.

### BRIEF DESCRIPTION OF THE DRAWINGS

FIG. 1 is a block diagram of an image processing apparatus according to an exemplary embodiment.

FIG. 2 is a block diagram of a blurred image generation unit according to the exemplary embodiment depicted in FIG. 1.

FIG. 3 is a flowchart of blurring processing according to the exemplary embodiment depicted in FIG. 1.

FIG. 4 is a flowchart of blur addition amount determination processing according to the exemplary embodiment depicted in FIG. 1.

FIG. 5 is a flowchart of vertical scanning processing.

FIG. 6 is a flowchart of horizontal scanning processing.

FIG. 7 is a flowchart of diorama determination processing.

FIG. 8A illustrates an example of a distance map with regard to a captured image, and FIG. 8B illustrates scanning directions.

FIG. 9 illustrates an example of a distance map with regard to a captured image.

FIG. 10 illustrates an example of scanning directions with regard to a captured image.

FIG. 11 illustrates blurring processing in the case where the determination of a horizontal diorama is made.

### DETAILED DESCRIPTION

Various exemplary embodiments, features, and aspects of the subject matter will be described in detail below with reference to the drawings.

An image capture unit 100 (image acquisition unit) receives a light flux, which enters an optical system, and outputs an image signal, which has been digitized through analog/digital (A/D) conversion. The image capture unit 100 includes a lens group, a shutter, a diaphragm, and an image sensor as constituting the optical system. The lens group includes a focusing lens. An image capture control circuit 101 can control the shutter, the diaphragm, and the focusing lens. The image sensor according to the exemplary embodiment is an X-Y address type complementary metal-oxide semiconductor (CMOS) sensor having RGB pixels in the Bayer pattern, but is not limited to it. Alternatively, the image sensor may, for example, be a charge coupled device (CCD) or a sensor in which complementary color pixels are arranged.

Image data output from the image capture unit 100 is input to an image processing unit 200 and can be stored in a memory 102 at the same time. The image data, which has been stored in the memory 102, can be read again, and a central processing unit (CPU) 114 can refer to the image data or input the read image data to the image processing unit 200.

The image data that has been subjected to image processing in the image processing unit 200 can be written back into the memory 102 or arbitrary data can be written in the image processing unit 200 from the CPU 114.

A display unit 116 can perform digital/analog (D/A) conversion of the digital image data, which has been subjected to the image processing in the image processing unit 200 and is stored in the memory 102, to display an image on a display medium such as a liquid crystal display. In addition, the display unit 116 can display not only the image data but also arbitrary information independently or along with an image and can display exposure information when capturing an image as well as can display a frame around a detected face area.

A recording unit 115 can store the captured image data into a recording medium such as a read only memory (ROM) and a secure digital (SD) card.

Processes in the image processing unit 200 which relate to the exemplary embodiment will be described. A white balance (WB) control unit 103 calculates a WB correction value based on information obtained from the image signal stored in the memory 102 to perform WB correction on the image signal stored in the memory 102. The detailed configuration of the WB control unit 103 and the method for calculating the WB correction value will be described later.

A color conversion matrix (MTX) circuit 104 applies color gain to the image signal that has been subjected to the WB correction by the WB control unit 103, such that the image signal is reproduced in optimal colors. A color conversion matrix (MTX) circuit 104 then converts the image signal into color-difference signals R-Y and B-Y. A low pass filter (LPF) circuit 105 regulates bandwidth of the color-difference signals R-Y and B-Y. A chroma suppression (CSUP) circuit 106 suppresses a false color signal of a saturated portion in the image signals, the bandwidth of which has been limited by the LPF circuit 105. Meanwhile, the image signal, which has been subjected to the WB correction by the WB control unit 103, is also output to a luminance signal (Y) generation circuit 112 in which a luminance signal Y is generated. The generated luminance signal Y is then subjected to edge emphasis processing in an edge emphasis circuit 113.

The color difference signals R-Y and B-Y output from the CSUP circuit 106 and the luminance signal Y output from the edge emphasis circuit 113 are converted into an RGB signal by an RGB conversion circuit 107, and the RGB signal is then subjected to gradation correction in a gamma correction circuit 108. Thereafter, the RGB signal is converted to YUV signal in a color luminance conversion circuit 109, and the YUV signal is then subjected to blurring processing, which is characteristic processing according to the exemplary embodiment, in a blurred image generation unit 110. A blurred image from the blurred image generation unit 110 is compressed by a joint photographic expert group (JPEG) compression circuit 111 to be written into the memory 102. The compressed data is recorded in the form of an image signal in an external or an internal recording medium. Alternatively, the blurred image is displayed on a display medium in the display unit 116. As another alternative, the blurred image may be output to an external output (not illustrated).

Each configuration described above may be partially or entirely configured as a software module.

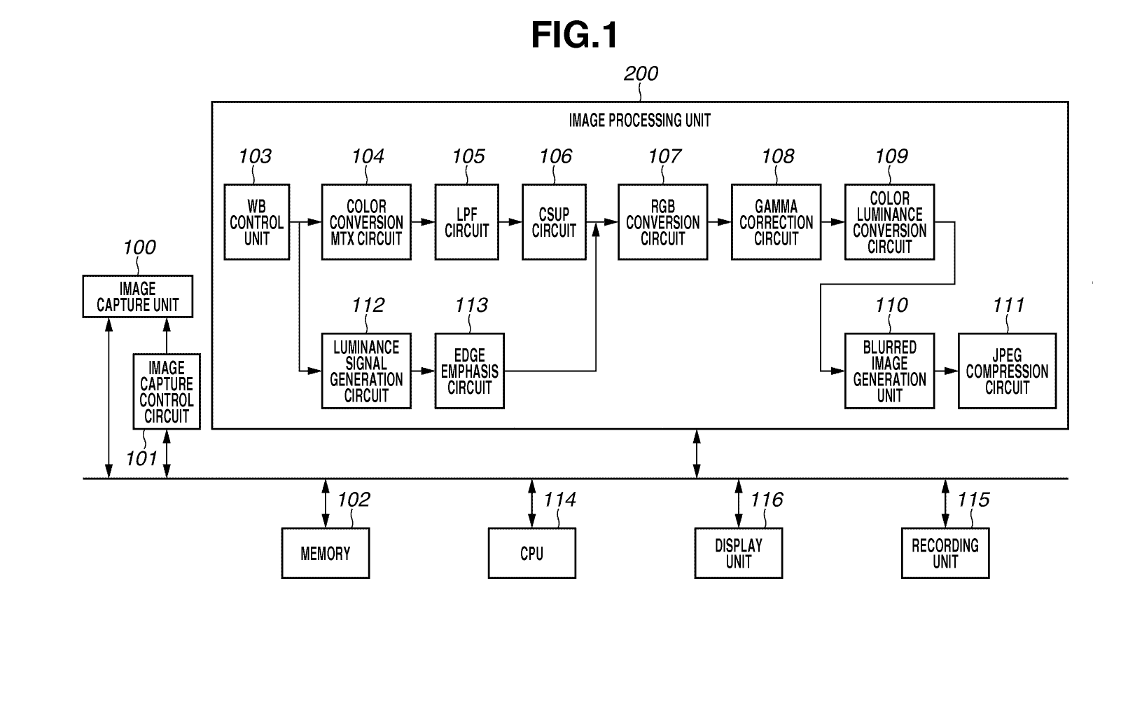

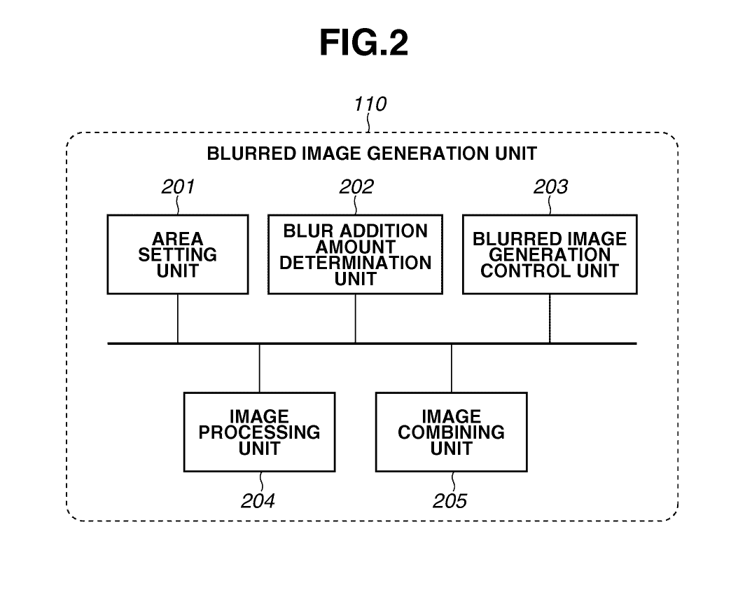

A configuration of the blurred image generation unit 110 will now be described. FIG. 2 illustrates a configuration of the blurred image generation unit 110 of FIG. 1. As illustrated in FIG. 2, the blurred image generation unit 110 includes an area setting unit 201, a blur addition amount determination unit 202, a blurred image generation control unit 203, an image processing unit 204, and an image combining unit 205.

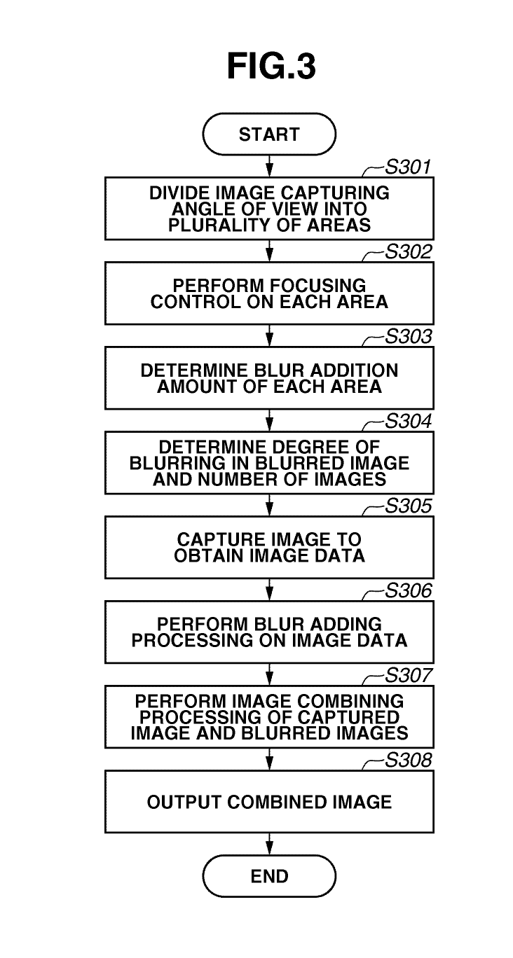

With reference to the flowchart illustrated in FIG. 3, a flow for blur adding processing to an image captured by the image capture unit 100 will be described.

In step S301, the area setting unit 201 divides the captured image within the angle of view into a plurality of areas. According to the exemplary embodiment, the area setting unit 201 divides the captured image within the angle of view into N1 equal parts in the vertical direction and N2 equal parts in the horizontal direction.

In step S302, the CPU 114 and the image processing unit 200 (distance information acquisition unit) performs focusing control in each area within the image to obtain distance information based on each area. In the focus control according to the exemplary embodiment, an AF evaluation value, which indicates contrast of the image data output from the image capture unit 100, is obtained in each focus control area while moving the focusing lens by the image capture control circuit 101. The AF evaluation value is output from the image processing unit 200 or can also be obtained through calculation by the CPU 114 based on the image data or an output of the image processing unit 200. Based on the obtained AF evaluation value of each focus control area with respect to a focusing lens position, a focusing lens position at which an evaluation value reaches a maximum (hereinafter, peak position) in each focus control area is obtained, and this peak position corresponds to the distance information of an object distance in each area. In other words, a distance map here corresponds to peak position information of N1×N2 matrix.

The method for obtaining the distance information of the object distance in each area is not limited to the method described above. For example, as a method for measuring the object distance by comparing two or more images each having a different focus position in the same angle of view, a method for estimating the distance through an edge difference or a method using a depth from defocus (DFD) can be considered. In addition, a focus control sensor for measuring the distance through a phase difference may be provided separately from the image capture unit 100. By arranging pupil-divided pixels with which focus detection can be performed through a phase difference in an array of pixels of an image sensor of the image capture unit 100, the distance may be measured based on output from the pixels for the focus detection.

In addition to the result obtained through focus control at an arbitrary position within a predetermined area, the mean of the results obtained through focus control at a plurality of positions within a predetermined area may be used as the obtained distance information.

In step S303, the blur addition amount determination unit 202 determines a blur addition amount in each area based on the distance information obtained for each predetermined area. The processing in step S303 will be described later in detail.

In step S304, the blurred image generation control unit 203 determines a degree of blurring in a blurred image and the number of blurred images to be generated based on the information of the blur addition amount, which has been determined for each area.

In step S305, the image capture unit 100 captures an image to obtain image data. At this point, the focus may be controlled such that the object is focused in an area, which has been set to be a nonblurring area by the image capture control circuit 101.

In step S306, the blurred image generation control unit 203 performs blur adding processing on the captured image data. The image processing unit 204 performs resizing processing and filtering processing on the image data to obtain a blurred image determined by the blur addition amount determination unit 202. In the resizing processing, the image processing unit 204 reduces the image data to an image size (a number of pixels) of 1/N (N is a resize coefficient determined in step S303), and then the image processing unit 204 enlarges the image data to the original image size via the filtering processing. In the filtering processing, the image processing unit 204 performs image filtering processing on the image data at the degree of blurring (filter coefficient) determined in step S304.

In step S307, the image combining unit 205 performs image combining processing of the captured image and the plurality of blurred images, which have been generated in step S306, based on the information of the blur addition amount in each area determined by the blur addition amount determination unit 202. Here, an example of the image combining processing will be described. The image combining unit 205 combines an image IMG1[i,j] to be combined and an image IMG2[i,j] to be combined based on a combining ratio α[i,j] (0≦α≦1) determined for each pixel to generate a combined image IMG3[i,j]. That is, the image combining unit 205 calculates the combined image IMG3[i,j] using formula (1) below. Here [i,j] indicates each pixel.

IMG3[i,j]=IMG1[i,j]*α[i,j]+IMG2[i,j]*(1−α) (1)

In step S308, the image capture unit 100 causes the display unit 116 to display the combined image on a display medium such as a liquid crystal display. Alternatively, the combined image is compressed through JPEG compression, and the recording unit 115 performs output processing to store the compressed image data into an external or internal recording medium.

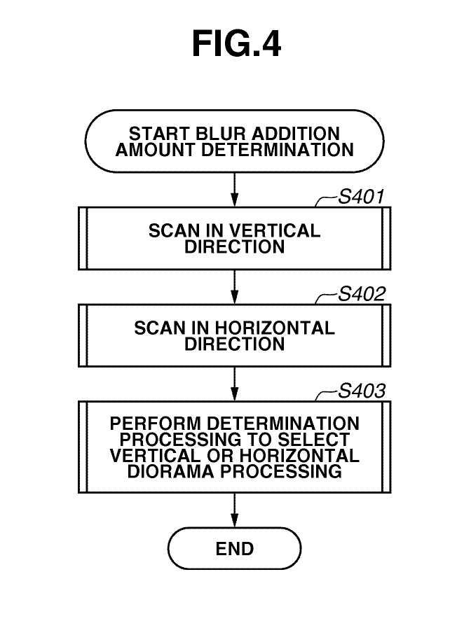

The blur addition amount determination processing in step S303 will be described in detail. FIG. 4 is a flowchart illustrating the operation in the blur addition amount determination processing.

In steps S401 and S402, the distance information obtained in step S302 illustrated in FIG. 3 is scanned in the vertical direction and in the horizontal direction, respectively, in order to determine whether the distance information of each area as a whole has gradation in the vertical direction and in the horizontal direction.

In step S403, the blur addition amount determination unit 202 performs determination processing for selecting vertical diorama processing or horizontal diorama processing based on the result obtained by the scans. In the vertical diorama processing, the blur amount gradually varies in the vertical direction, and in the horizontal diorama processing the blur amount gradually varies in the horizontal direction.

In step S403, if the blur addition amount determination unit 202 determines that the current image data is not suitable for diorama processing, background blurring processing, in which a blur addition amount increases as the distance from the object increases with the object as a center, is performed in later steps illustrated in FIG. 3. Alternatively, the flow illustrated in FIG. 3 is terminated without blurring the image. With regard to the determination of the background blurring processing or nonblurring processing, the nonblurring processing can be selected, for example, when a distance difference between the object and the background is less than a predetermined value or when the size of the detected object is less than a predetermined lower limit size or greater than a predetermined upper limit size.

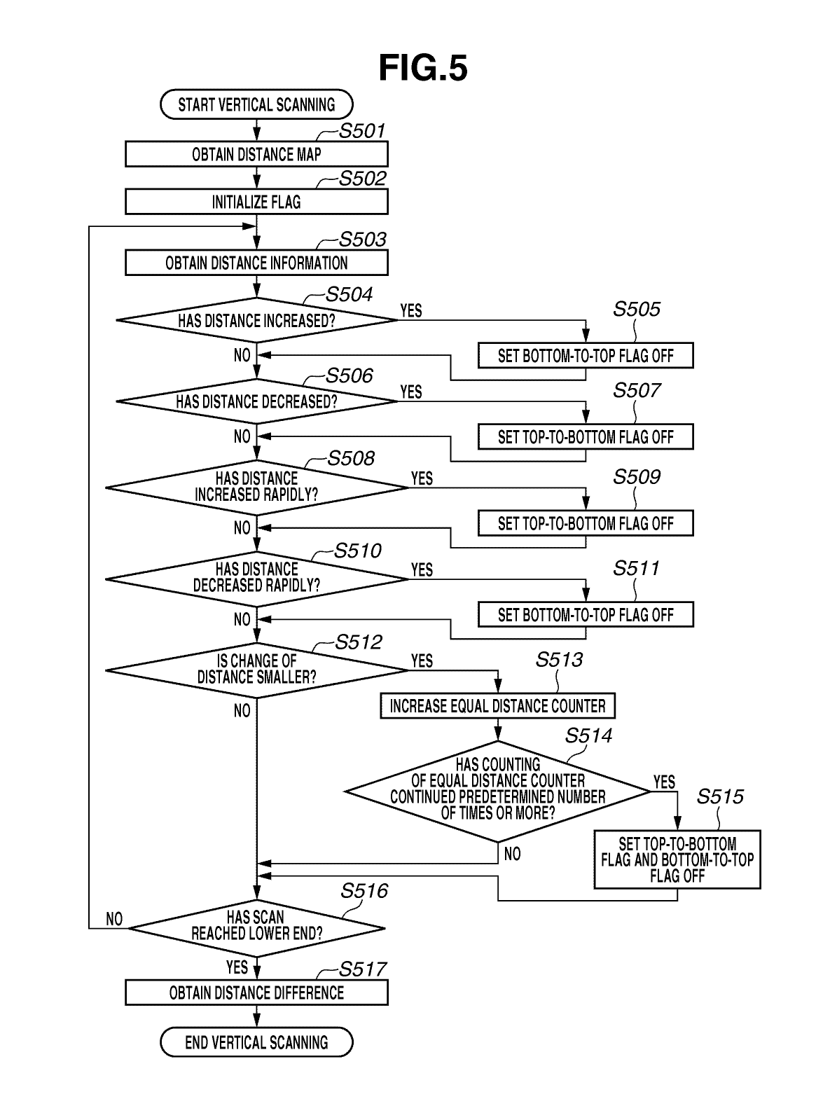

FIG. 5 is a flowchart for describing the operation for detecting a distance change in a certain direction.

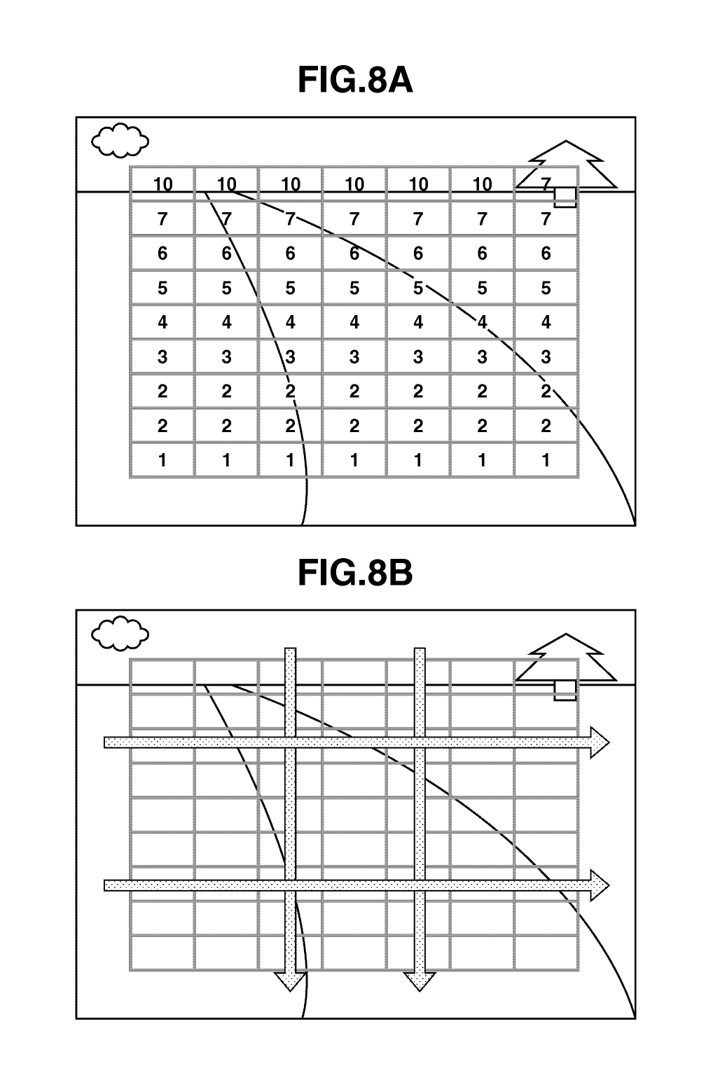

Directions in which the distance change is scanned are indicated in FIG. 8B, and FIG. 8B indicates a state scanning horizontally and vertically within the angle of view. The operation flowchart illustrated in FIG. 5 is for detecting the distance change in the vertical direction, therefore, corresponds to the scan in the direction indicated by the arrows extending from the top to the bottom in FIG. 8B.

In step S501, the distance map generated in step S302 is obtained. FIG. 8A illustrates an example of the distance map obtained through a distance map obtaining operation. The image in the angle of view is divided into a plurality of blocks, and as an example illustrated in FIG. 8A, the image in the angle of view is divided into seven blocks in the horizontal direction and nine blocks in the vertical direction. The obtained distance from the object is indicated by the unit of meters in each of the block.

In step S502, a determination flag is initialized. There are a total of five flags. Two flags indicate a gradual distance change from the top to the bottom in the angle of view, namely, the top corresponds to the front and the bottom corresponds to the depth. Another two flags indicate a gradual distance change from the bottom to the top in the angle of view, namely, the bottom corresponds to the front and the top corresponds to the depth. In addition, a vertical flat flag indicates a state where a distance difference is not present in the vertical direction. In step S502, all of the flags are initialized to an ON state.

In step S503, the distance information is obtained from the distance map obtained in step S501.

In steps S504, S506, S508, S510, and S512, the distance obtained in step S503 is compared with the previously obtained distance. When the distance is obtained first time, data to be compared with is not present, and thus the determination turns out to be NO in all steps. Here, in steps S504 and S506, a flag operation is performed according to a change in distance. For example, in step S504, it is determined whether the distance has increased this time comparing with the distance obtained previously. If the distance has increased, a bottom-to-top flag is set to OFF since the increase indicates that the top in the angle of view corresponds to the front and the bottom corresponds to the depth. Similarly, in step S506, a top-to-bottom flag is set to OFF if the bottom corresponds to the front and the top corresponds to the depth.

In steps S508 and S510, a gradual change is detected. For example, in step S508, even if the top in the angle of view corresponds to the front and the bottom corresponds to the depth, when the change in distance is greater than a predetermined value, the change is not considered monotonous, and the top-to-bottom flag is set to OFF. A similar operation is performed in step S510.

In step S512, it is for the angle of view in which the distance change is less than a predetermined value. If a state where the distance does not change or hardly changes continues, an equal distance counter is provided and, in step S513, a counting number by the equal distance counter is stored. In step S514, if the counting of the equal distance counter continues a predetermined number of times or more, the change is not considered monotonous, and, in step S515, the top-to-bottom flag and the bottom-to-top flag are both set to OFF.

In step S516, it is determined whether the scan in the vertical direction has reached the lower end, and if the scan has reached the lower end, the processing proceeds to step S517.

In step S517, a distance difference is obtained from the minimum value and the maximum value of the distance information obtained in step S503. If the distance difference is equal to or greater than a predetermined difference, the vertical flat flag is set to OFF, and the operation for detecting the distance change in the vertical direction ends. If any one of the flags has been set to ON through each of the steps in FIG. 5, the object distance in the direction indicated by the flag can be determined to be on a monotonous increase or on a monotonous decrease by an increase/decrease amount within a certain range.

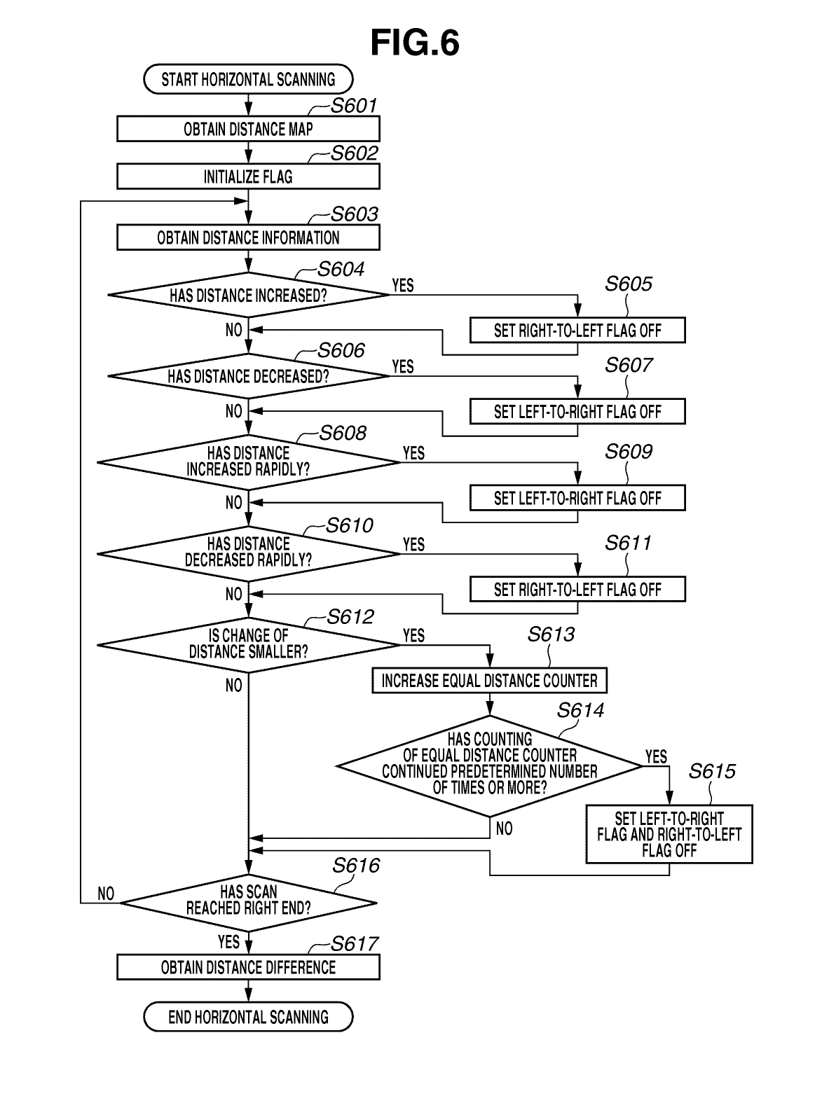

FIG. 6 is a flowchart for describing the operation detecting a distance change in another certain direction. FIG. 6 illustrates an operation detecting the distance change by horizontally scanning the angle of view. The scanning operations in steps S601 to S617 are performed in the horizontal direction, which differ from the operations in steps S501 to S517 of FIG. 5 in which the scanning operation is performed in the vertical direction, and thus detailed description thereof will be omitted. In FIG. 6 as in FIG. 5, the determination operation is performed using a total of five flags. Two flags indicate the distance change from the right to the left in the angle of view, namely, the right corresponds to the front and the left corresponds to the depth. Another two flags indicate the distance change from the left to the right in the angle of view, namely, the left corresponds to the front and the right corresponds to the depth. In addition, a horizontal flat flag indicates a state where a difference in the distance is not present in the horizontal direction.

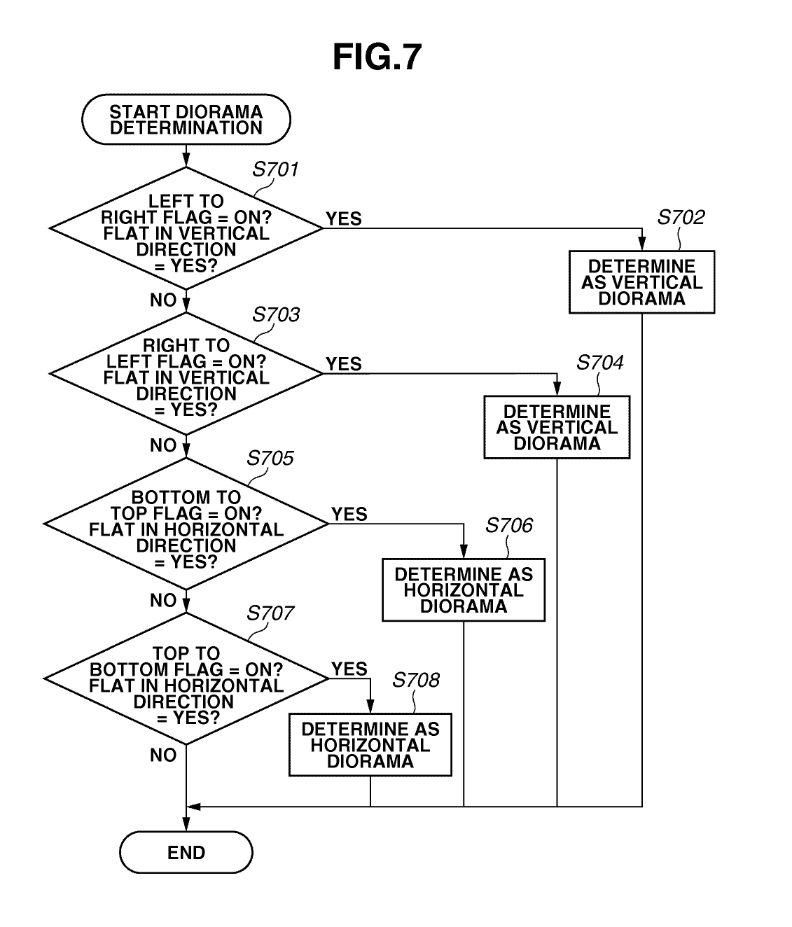

FIG. 7 is a flowchart describing the diorama determination processing.

A final determination is performed to a direction in which the distance increases within the angle of view using the detection of distance changes in vertical and horizontal directions through the operations illustrated in FIGS. 5 and 6.

In step S701, when the left-to-right flag is set to ON through the operations in FIG. 6 and also the distance difference in the vertical direction is determined to be smaller through the operations in FIG. 5 (YES in step S701), the processing proceeds to step S702.

In step S703, when the right-to-left flag is set to ON through the operations in FIG. 6 and also the distance difference in the vertical direction is determined to be smaller through the operations in FIG. 5 (YES in step S703), the processing proceeds to step S704.

The determination result being YES in each of steps S701 and S703 indicates a scene in which the distance difference is not present in the vertical direction within the angle of view and the distance increases in the horizontal direction. For example, an image of a bookshelf or the like being captured at an angle corresponds to such a case. In steps S702 and S704, the final determination is made as the vertical diorama. Specifically, a nonblurring area is set in the vertical direction within the angle of view and a blurring area is set in the horizontal direction, and thus blurring processing along the direction in which the distance of the object increases can be performed.

In step S705, when the bottom-to-top flag is set to ON through the operations in FIG. 5 and also the distance difference in the horizontal direction is determined to be smaller through the operations in FIG. 6 (YES in step S705), the processing proceeds to step S706.

In step S707, when the top-to-bottom flag is set to ON through the operations in FIG. 5 and also the distance difference in the horizontal direction is determined to be smaller through the operations in FIG. 6 (YES in step S707), the processing proceeds to step S708.

The determination result being YES in each of steps S705 and S707 indicates a scene in which the distance difference is not present in the horizontal direction within the angle of view and the distance increases in the vertical direction. For example, a distant view illustrated in FIG. 8A corresponds to such a case. In steps S706 and S708, the final determination is made as the horizontal diorama. Specifically, a nonblurring area is set in the horizontal direction within the angle of view and a blurring area is set in the vertical direction, which is orthogonal to the horizontal direction, and thus blurring processing along the direction in which the distance of the object increases can be performed.

Accordingly, the detection of a scene in which the distance increases in the vertical or the horizontal direction within the angle of view and the diorama determination processing have been described.

As illustrated in FIG. 8B, there are two scanning lines in each of the vertical and the horizontal directions, and two flags are prepared to correspond to the number of the scanning lines. Thus, the diorama determination can be made based on an AND operation of two determination locations, and thus more certain determination processing can be performed.

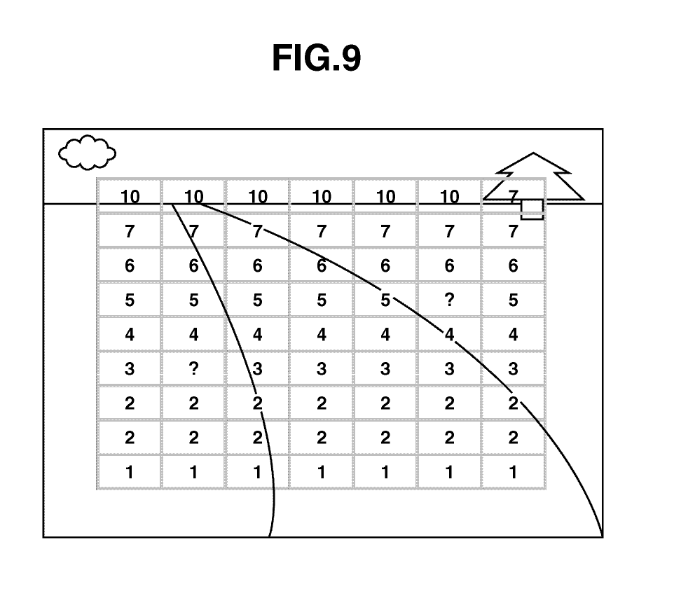

FIG. 9 illustrates an example that includes a block in which the distance is undetermined in the distance map illustrated in FIG. 8A. According to the exemplary embodiment, the distance map is generated using the distance information obtained when performing the contrast AF, therefore, there are cases where an AF peak cannot be detected in a block with low contrast and the distance thus cannot be obtained.

Several processes can be considered when the distance is undetermined. As an example, there is a method in which processing is performed without using and with skipping a block in which the object distance is undetermined at the detecting operation of the distance change illustrated in FIGS. 5 and 6. As another example, there is a method in which the distance is obtained through interpolation calculation from surrounding blocks in which the object distances have been measured. The method for handling such a block, however, is not limited to the above.

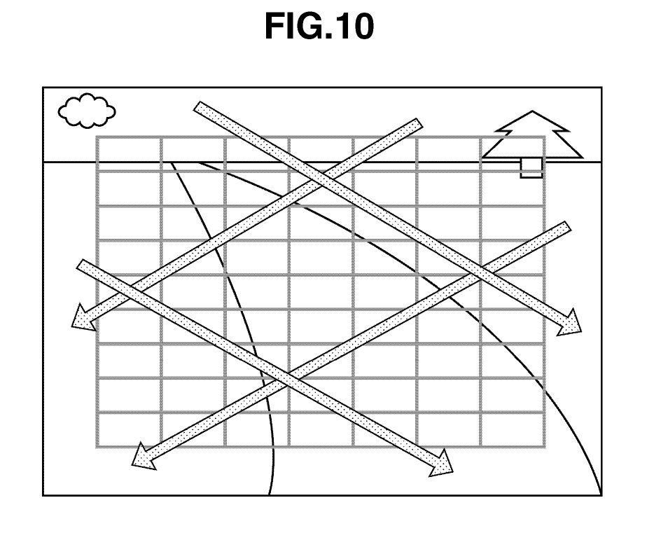

FIG. 10 illustrates an example in which the distance increase in a diagonal direction is detected with regard to the operation for detecting the distance change described with reference to FIGS. 5 and 6. The operation for detecting the distance increase in the diagonal direction is similar to the operations in the case of the vertical and horizontal directions. Detecting a scene in which the distance increase in the diagonal direction is enabled by using a distance change flag in the case of scanning in a diagonal direction and a flat determination flag in a direction orthogonal to the scanning direction.

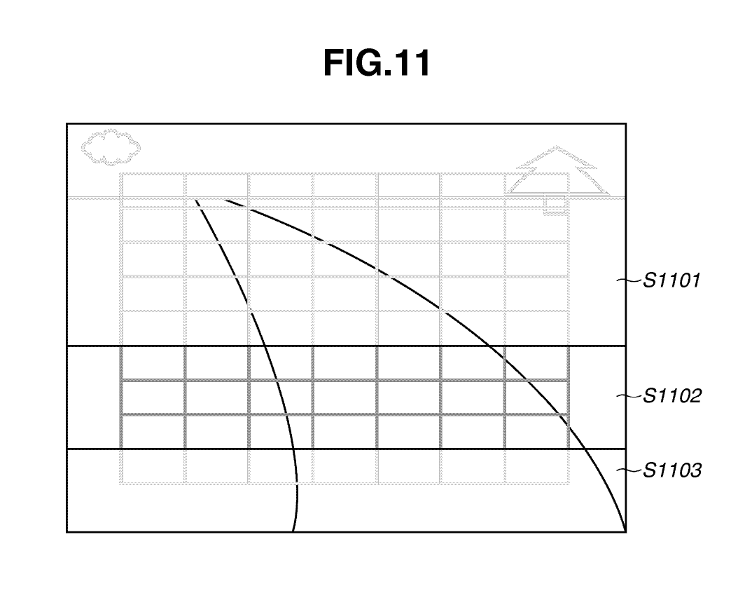

FIG. 11 illustrates an example of blurring processing if the horizontal diorama is determined in step S706 of FIG. 4. Specifically, a nonblurring area is set in an area 51102 and blurring areas are set in areas 51101 and S1103, and thus blurring processing along the direction in which the distance increase of the object can be performed.

As described above, according to the exemplary embodiment, in the case where the blurring processing is performed based on the distances in the plurality of blocks within the angle of view, even if the AF fails to measure the distance correctly when, in particular, the distance is to be obtained through the AF, the blurring processing can be performed uniformly without producing unnaturalness around a border area.

In addition, although the method in which a single continuous nonblurring area is set within the angle of view has been described above, the exemplary embodiment is not limited thereto, and a plurality of nonblurring areas may be set.

The exemplary embodiment of the present subject matter has been described in detail with reference to the above specific example. However, it is apparent that a person skilled in the art can make modifications and substitutions to the exemplary embodiment without departing from the scope of the present subject matter.

Although the above example according to the exemplary embodiment, which is applied to a digital still camera, is mainly described, the exemplary embodiment of the present subject matter is not limited thereto. For example, the exemplary embodiment of the present subject matter can be applied in a similar manner to a portable telephone, a personal digital assistant (PDA), or various other information devices equipped with a camera function.

The exemplary embodiment of the present subject matter discussed above has been disclosed as an example embodiment, and should not be construed as limiting the scope of the present subject matter.

In addition, the exemplary embodiment of the present subject matter can be applied not only to a device that is primarily configured to capture images, such as a digital camera, but also to any arbitrary device having an image capture device therein or externally connected thereto, such as a portable telephone, a personal computer (notebook type, desktop type, tablet type, etc.), and a game apparatus. Accordingly, the “image capture device” according to the exemplary embodiment is intended to encompass any given electronic device equipped with an image capture function.

According to the exemplary embodiment of the present subject matter, in the case where the blurring processing is performed by using the distances in a plurality of blocks obtained by dividing an image, even if the AF fails to measure the distance correctly, the blurring processing can be performed uniformly.

Embodiments of the present subject matter can also be realized by a computer of a system or apparatus that reads out and executes computer executable instructions recorded on a storage medium (e.g., non-transitory computer-readable storage medium) to perform the functions of one or more of the above-described embodiment(s) of the present subject matter, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™, a flash memory device, a memory card, and the like.

While the present subject matter has been described with reference to exemplary embodiments, it is to be understood that the subject matter is not limited to the disclosed exemplary embodiments. The scope of the following claims is to be accorded the broadest interpretation so as to encompass all such modifications and equivalent structures and functions.

This application claims the benefit of Japanese Patent Application No. 2012-285262 filed Dec. 27, 2012, which is hereby incorporated by reference herein in its entirety.

What is claimed is:

1. An image processing apparatus, comprising:
an image acquisition unit configured to acquire image data;
a distance information acquisition unit configured to acquire distance information from a plurality of areas of the image data;
a detection unit configured to detect whether the distance information changes gradually in a certain direction within an image of the image data; and
a blurring processing unit configured to perform blurring processing in a direction orthogonal to the certain direction if the detection unit has detected that the distance information changes gradually in the certain direction.

2. The image processing apparatus according to claim 1, wherein detection by the detection unit comprises scanning the image of the image data in a plurality of directions including a horizontal direction, a vertical direction, and a diagonal direction.

3. The image processing apparatus according to claim 1, wherein detection by the detection unit comprises determining that the image has a gradual change if an object distance increases or decreases monotonously.

4. The image processing apparatus according to claim 1, wherein detection by the detection unit includes determining that the image has a distance change in the certain direction if the distance change in a direction orthogonal to a direction in which the distance changes gradually is small.

5. The image processing apparatus according to claim 1, wherein detection by the detection unit includes, with regard to an area for which distance is unable to be acquired by the distance information acquisition unit, omitting the use of the area or obtaining the object distance in the area through an interpolation calculated from surrounding areas.

6. An image processing method, comprising:
acquiring image data;
acquiring distance information in a plurality of areas in the image data;
detecting whether the distance information changes gradually in a certain direction within an image of the image data; and
performing blurring processing in a direction orthogonal to the certain direction if the distance information has been detected to change gradually in the certain direction.

7. A non-transitory computer-readable storage medium storing a program that when executed, causes a computer to perform the image processing method according to claim 6.
